(19) United States
(12) Patent Application Publication
(10) Pub. No.: US 2003/0153991 A1
(43) Pub. Date: Aug. 14, 2003

(54) Compliance management system

(76) Inventors: Ron J. Visser, Calgary (CA); A. Murray Smith, Calgary (CA)

Correspondence Address: SEAN W. GOODWIN, 237- 8TH AVE. S.E., SUITE 360, THE BURNS BUILDING, CALGARY, AB, T2G 5C3, CA

(21) Appl. No.: 10/199,074

(22) Filed: Jul. 22, 2002

Related U.S. Application Data
(60) Provisional application No. 60/356,180, filed on Feb. 14, 2002.

(51) Int. Cl. G05B 9/02

(52) U.S. Cl. 700/79; 700/83

(57) ABSTRACT

An organization can manage its compliance through a system and process for collecting characteristic data for regulated elements and applying a rule application system to identify those having an out-of-compliance status. A responsible representative is assigned and notified of the out-of-compliance status and compelled to perform corrective actions through repeated and successive notification of the assigned representative and a hierarchy of responsible representatives until compliance is achieved. Compliance is further compelled through assigning a default out-of-compliance status for an element until such time as its characteristics are collected such as through mandatory data collection. Preferably, the compliance management system is implemented in a client-server network utilizing remote data collection devices and server-based applications and databases of rules, a corrective action register of pending out-of-compliance elements and a compliance calendar interface for responsible representatives.

### CROSS REFERENCE TO RELATED APPLICATION

This application is a regular application of U.S. Provisional Patent Application Serial No. 60/356,180 filed on Feb. 14, 2002, the entirety of which is incorporated herein by reference for all purposes.

### FIELD OF THE INVENTION

The invention relates to a system and a methodology for managing compliance to rules. More particularly, data for characteristics of elements is periodically obtained from data collecting devices and rules are applied for determination of the element's compliance status and for escalating notification of a hierarchy of successive responsible representatives so as to compel correction of an element's out-of-compliance status.

### BACKGROUND OF THE INVENTION

There are a multitude of industries that are subject to rules or regulations and enforcement thereof. Two diverse examples of organizations representative of such industries are a hydrocarbon production facility and a medical laboratory. For an affected individual, an organization, or more broadly an entity, to properly comply with the rules, it must remain aware of the changing regulatory regime as this regime applies to various aspects or elements of its operations. Moreover, the entity is often charged with the duty to monitor data that is characteristic of a task or of a piece of equipment and further to assess whether the characteristic data of such an element is within acceptable parameters of one or more applicable rules. Further, the entity may choose to operate in a manner that exceeds minimum compliance requirements, or establish its own policy or rules, even if there are no regulated compliance requirements.

Regardless of whether or not an entity operates in a manner that exceeds minimum compliance requirements, several problems or challenges arise when attempting to manage all the elements in an entity's operation including:

the entity is not aware of the rules, or changes in the rules;

while the entity may be aware of the rules and any changes, those responsible for implementation, such as employees, are not made aware of the changes;

those responsible for implementation, even if aware of the rules and any changes in the rules, are not motivated or otherwise compelled to comply;

even if the entity or its responsible representatives wish to comply, they are not adequately informed about the steps required to identify the characteristics, or criteria, or comply with the rules; and

the entity does not have the tools or mechanisms to adequately manage all the elements within its responsibility.

Furthermore, as personnel change, the accumulated knowledge of which characteristics for each monitored element that are actually pertinent for compliance, and how to gauge whether or not the monitored elements are in compliance, are often lost with the responsible yet departing employee. It is difficult to ensure that such knowledge is passed on to the next generation of employees or is effectively utilized by all existing personnel.

A traditional way of implementing the monitoring of all of an entity's elements, and to inform those responsible for such implementation of the rules and any changes, is through a paper-based check-list and manual system. However, often the paper medium that is used to document or disseminate the knowledge of the applicable compliance criteria is only recorded in a fixed form, has limited access, is irregularly updated, and is cumbersome to utilize in the field.

Various computer systems and methods have been widely used to automate this monitoring component of compliance management by applying the rules and regulations stored in one database to the characteristics of an entity's monitored elements stored in another database and flagging or otherwise identifying those elements out of compliance. Such rule application systems primarily assist in identifying cases of compliance and non-compliance, but would also presumably allow for easy regular updates of the compliance criteria and rules.

One example of such a computerized rule application system is disclosed in U.S. Pat. No. 5,623,403 to Highbloom. Highbloom teaches a computer apparatus and method for identifying non-compliance with motor vehicle registration laws by comparing two sets of information at periodic intervals to detect instances of non-compliance. When such instances are detected the invention of Highbloom flags the appropriate records and generates reports and communications to notify an entity and allow it to take the appropriate remedial action. Similarly, U.S. Pat. No. 6,163,732 teaches a computer system and method for determining compliance of a chemical product to the government regulations that govern the product. There, the chemical's composition is compared by the computer system to a stored set of government regulation standards and flagged as either complying or non-complying.

Despite these automated rule application systems, there is still a need for a system that can address all of an entity's concerns regarding compliance management, including:

making an entity aware of the rules, or changes in rules, applicable to their particular situation;

compelling periodic updating of element data by authorized and responsible entity representatives and employees;

notifying the entity if a characteristic of a particular aspect of the entity's operations is out-of-compliance;

providing up-to-date instructional means to the entity's employees so as to enable them to understand what is a monitored element, what are its characteristics, and whether they are in compliance;

compelling the authorized representative to remediate an out-of-compliance status; and

allowing for dynamic reporting and trend analysis of implementation.

### SUMMARY OF THE INVENTION

The compliance management system comprises effective data collection and notification techniques for providing an entity with the best opportunity to remain in compliance with applicable rules and policy. The entity and its representatives responsible for correcting out-of-compliance elements are provided with integrated tools for managing elements within its control. In a preferred embodiment of the invention, data that is characteristic of each of a plurality of regulated elements is collected and communicated to a server computer for the application of a rule application system. A responsible representative is assigned and notified of the out-of-compliance status and compelled to perform corrective actions through repeated and successive notification of the assigned representative and a hierarchy of responsible representatives until compliance is achieved. The representatives are notified through an interactive calendar that is linked to a corrective action register containing entries or corrective action events for each element that is out-of-compliance. The register itself is an interactive interface for determining the nature of an element's out-of-compliance status and the means for correction.

Accordingly, in a broad aspect, a method is provided for directing compliance of an entity to rules applicable to one or more elements, the method comprising the steps of: collecting data for each element; applying a computerized rule application system to each element's data for identifying whether each element has an in-compliance status or an out-of-compliance status; entering a corrective action event in a corrective action register for each element having an out-of-compliance status; and notifying a succession of responsible representatives selected from a hierarchy of representative for each corrective action event until each element having a corrective action event has been corrected to an in-compliance status and removed from the corrective action register.

Preferably, data characteristic of the element is collected and communicated to a server implementing the rule application system and representatives are notified through the data collection device or other devices on the network. Upon a triggering event such as the expiry of a predetermined period of time, successive representatives are notified of an element's continuing out-of-compliance status to further encourage compliance. More preferably, a calendar interface provides an assigned responsible representative with access to a chronological summary of corrective action events and details about an element's out-of-compliance status.

A system capable of implementing the method of the invention comprises: a network; at least one data collection device, adapted for connection to the network, for collecting data for one or more characteristics of at least one element; a server computer system, adapted for connection to the network and for receiving said data from the data collection device and for storing said data; a rule application program for applying compliance rules to the data for identifying an element having an out-of-compliance status; and means such as that on the network for notifying a responsible representative of the out-of-compliance status of the element.

### BRIEF DESCRIPTION OF THE DRAWINGS

FIG. 1a is a simplified schematic illustrating one embodiment of the invention illustrating collection of data, application of rules and notification of a responsible representative;

FIG. 1b is a simplified schematic illustrating a second embodiment of the invention illustrating notification of a succession of responsible representatives in a hierarchy;

FIGS. 2a-2c are flowcharts of various embodiments of a procedure for directing entity compliance, more specifically and respectively for compliance identification and notification, for periodic application of the rules, for determination of the need for periodicity, and for an overall system for updating rules, rule application and notification of a hierarchy of responsible representatives;

FIGS. 3a-3d are screen images of computer interfaces screen-images illustrating several levels of a register for the identification of action elements and correction of out-of compliance elements;

FIGS. 4a-4f are screen images of a compliance calendar computer interface for displaying the compliance status of a plurality of elements and for adding additional corrective action events;

FIGS. 5a-5i are screen images of one embodiment of a mandatory data collecting device that presents elements having characteristics to be collected for compliance determination;

FIG. 5j is a screen-image of one embodiment of a report, information or checklist generated by the system such as that produced after having processed data collected by the mandatory data collecting device of the embodiment as shown in FIGS. 5a-5i;

FIGS. 6a-6c are screen images of various levels in one embodiment of an administrator's interface for making adjustments to entries in the databases; and

FIG. 7 is a diagrammatic representation of the architecture of a compliance management system for an entity, its operations concerning hydrocarbon production facilities, and its personnel.

### DETAILED DESCRIPTION OF THE PREFERRED EMBODIMENTS

A compliance management system aids an entity in managing aspects of its operations or business that are subject to criteria, rules or regulations, collectively referred to herein as rules. The rules may be varied and fluid. More particularly, an entity implementing such a system is directed to achieve compliance if at all possible. An entity can include an individual, a business or some form of organization. The present invention provides apparatus and methodology for monitoring these aspects and assisting the entity in ensuring continued compliance and compel correction should an element of their operation or business become out of compliance.

The system may be operated wholly in-house, operated thorough a remote application service provider in communication with the entity, or some combination thereof. The system permits access by authorized users or representatives specified by the entity.

Elements and their Characteristics

Non-compliance to various rules can result in hazards including those adversely affecting personnel, equipment or other aspects of the operation, and can also adversely affect the environment. In an industry such as a medical laboratory setting, non-compliance can also result in inaccurate results and poor precision, either of which can also result in a hazard. Non-compliance can also result in unacceptable performance.

Typically there are rules in place to preempt hazards, inaccurate results, poor precision and unacceptable performance. Whether or not the entity itself enforces their own compliance, the entity may be subject to strict compliance through rules imposed by others. Non-compliance with these rules is typically enforced by the imposition of penalties. Rules can require that periodic inspections be undertaken, that equipment be maintained to achieving a certain level of safety, precision or reliability, that products have a specified minimum quality, or that personnel maintain a certain minimum level of qualifications and training. Accordingly, the system can be applied to inanimate and animate aspects or elements.

Each element has characteristics that are defined or somehow quantified (for example: measures including numerical quantification or logical true-false attributes). The element's characteristics are required to meet specified requirements or else be deemed out of compliance. Non-compliance is usually identified through inspection and collection of data defining the state of the characteristics; typically any one characteristic being out of compliance rendering the element out of compliance. An entity having even one of its elements out of compliance can be subject to penalties including fines or other punitive measures such as the loss of accreditation.

For example, a storage tank at a well-site can be an element. There is at least one rule associated with such tanks. An example of a characteristic of the entity's tank element is whether it is leaking or not (a logical true-false characteristic); a rule being that any leak means the characteristic and this element are out-of-compliance.

Further examples include: an employee at a well-site, and characteristics that can be re quantified include the employee's years of experience (a numerical quantification), level of education, and completion of applicable certifications; a volumetric flask and whether it is of certified accuracy (a logical true-false characteristic); and a medical sample storage refrigerator and its characteristic could be the operating temperature or range (a numerical quantification that, depending on the applicable rules, may need to be monitored daily).

Typically, the entity assigns at least one responsible representative, usually an employee, who is responsible for the periodic inspection of one or more of the monitored elements and their characteristics. Multiple representatives may be responsible for monitoring different characteristics of an element, for monitoring a plurality of elements and characteristics, or for supervising subordinate responsible representatives.

Alternatively, monitoring of one or more of the elements may be done by means of an autonomous data collection device that automatically gathers the appropriate characteristic data over a period of time. Autonomous data acquisition or collection devices include, among others, personnel entry logging, and sensors including pressure, emission and light. For example, an emission sensor may be installed on site to gather data regarding the amount of pollutants being released into the atmosphere. Similarly, a digital thermometer may be installed in a refrigerator to gather temperature data.

Compliance Management System—Overview

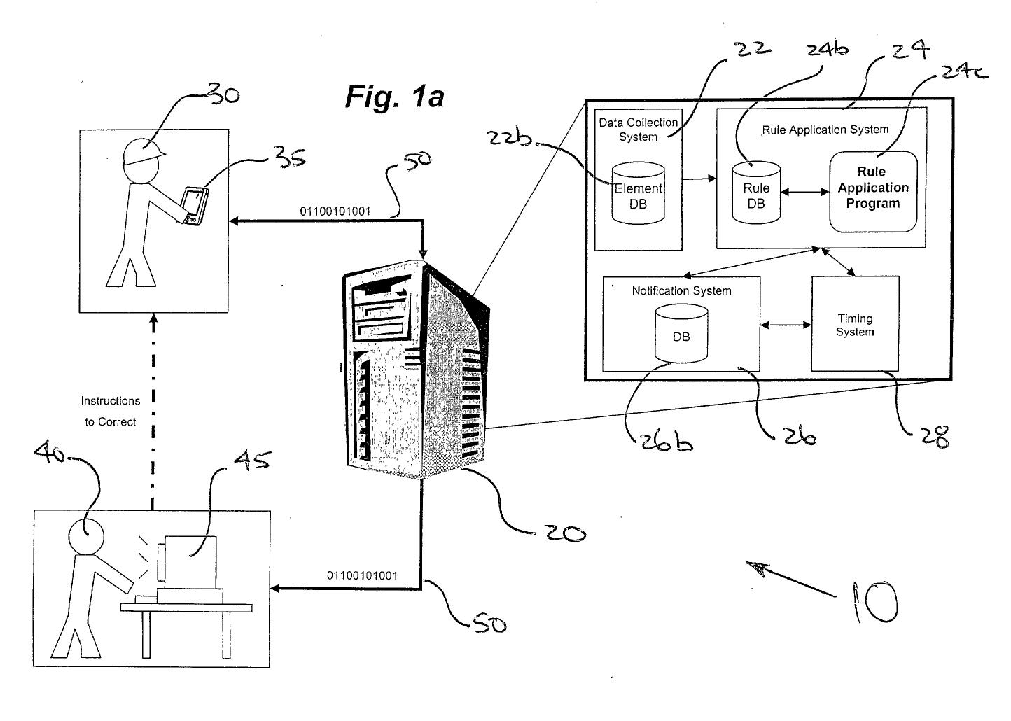

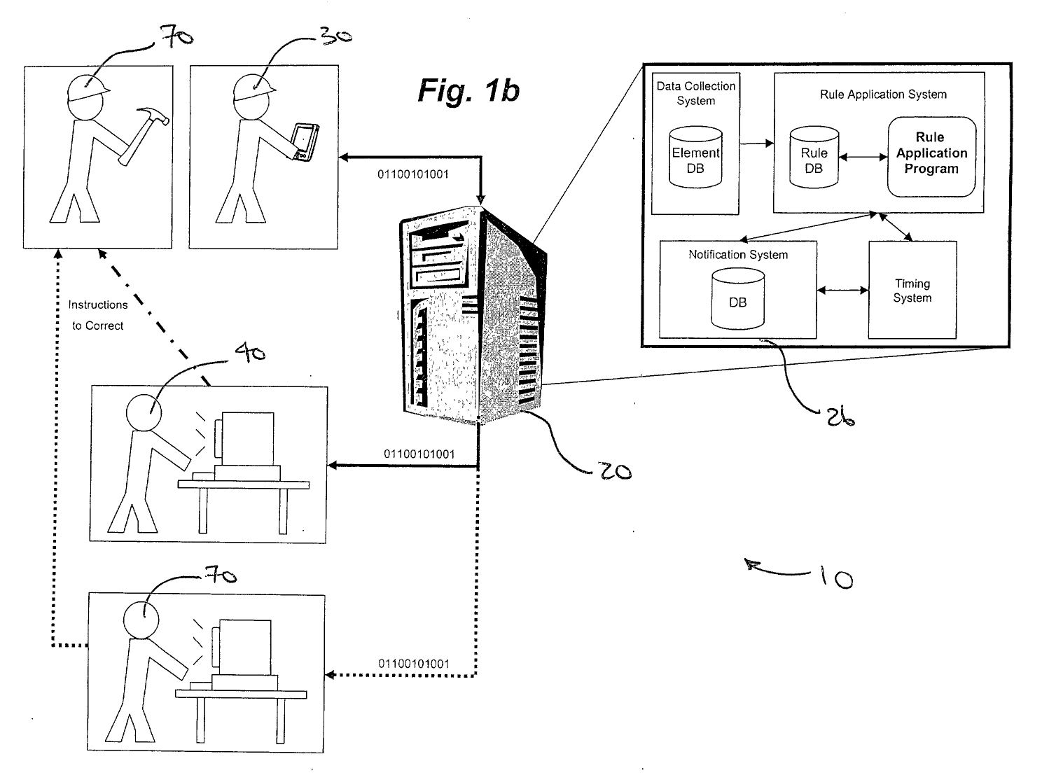

With reference now to FIG. 1a, there is shown a general overview of one embodiment of a compliance management system 10. The system 10 comprises a main or server computer 20 having conventional processing, data storage, input and output means. The server computer 20 can be a unitary or a distributed system. An initial responsible representative 30 may be employed to utilize a data collecting device 35 capable of communication with the server computer 20. The data collecting device 35 is part of a data collection system 22 and is a convenient and typical interface for the collection and input of element characteristics, ultimately for storage in an element database 22b. In the usual situation, the data collection device 35 is implemented at the location of the element to be monitored for compliance. Accordingly, an initial responsible representative 30 attends at an element's location. A successive responsible representative 40 is provided with a terminal 45 for access and communication with the server computer 20. The successive and initial responsible representatives 40,30 may be the same individual, but typically are different individuals for larger entities. The successive responsible representative 40 could be a superior of the initial representative 30.

An entity interacts with the system 10 through its various representatives, including the responsible representatives 30, 40 illustrated in this embodiment. The server computer 20 operates a data collecting system 22 that includes the element database 22b, a rule application system 24 comprising a rule application program 24c for implementing rules selected from a rule database 24b. A notification system 26 is triggered due to non-compliance. Triggering can include that determined through application of the rule application system 24, by a timing system 28, or by a change in the element database 22b itself.

The rules in the rule database 24b include those prescribed by legislation and regulations, those taught by an entity's experience including know-how, industry standard rules, as well as an entity's own rules such as those concerning those operations where it operates in a manner that exceeds the minimum compliance requirements or an entity's own policy, such as where there are no minimum compliance requirements. The server computer 20 also operates the timing system 28 for monitoring the passage of time and periodicity.

The three systems 22, 24, 26 may each utilize their own separate databases or they may share one or more databases. As set forth in FIG. 1a, the databases comprise:

the element database 22b of one or elements, each element having characteristics having a quantifiable state (characteristic data), at least some of the characteristics being associated with compliance rules, the quantifiable state includes logical values, yes/no values, and numerical values;

the rule database 24b of rules associated with at least one of the one or more characteristic data for the elements; and

a notification database 26b of notification and related entries associated with out-of-compliance element characteristics.

It is clear to those of skill in the art that the data in the element, rule and notification databases could be combined and managed in one or a plurality of databases. A database program that is suitable for containing all of the element, rule and notification data is the open-source PostgreSQL database program that allows for multiple tables of data in one large database. PostgreSQL is an Object-Relational DBMS, supporting almost all SQL constructs, including subselects, transactions, and user-defined types and functions. Other commercial database programs have similar functionality and include the Oracle™ database program from Oracle Corporation, Redwood Shores, Calif., USA.

As mentioned above, the entity has its own monitored elements that are a sub-set of the all the elements associated with rules. In this embodiment, to ensure complete compliance of all elements with the rules, the database system tracks the characteristics for the entire element database 22b and assumes that an element that is not monitored is out-of-compliance and accordingly assigns it an appropriate default value (that will then result in an out-of-compliance status when the rules are applied). Furthermore, in one approach to initialize the compliance management systems and prior to the first review of an entity's monitored element characteristic data, all elements in the database system are considered out-of-compliance and are each assigned an appropriate default value.

The server computer 20 is accessible to the entity representatives 30, 40 such as through a distributed network 50 such as the Internet. However, the server computer 20 may also be a stand-alone computer, with data being uploaded and downloaded via recordable media (including diskettes, CD's, CD-R's, CD-RW's, Zip-Disks™, optical disks, memory sticks, secure digital card, compact-flash card) or other means (including Infra-Red communications). An interface includes reports and other output being displayed on the computer's screen or output using other means including printed media and facsimile transmission.

The server computer 20, and the entity's representatives' 30, 40 access thereto creates a distributed client-server network. This distributed client-server network system preferably uses an interface designed with, and written in a substantially platform independent language such as Java™ Technology. This allows the application programs to be written in the platform-independent language for ensuring portability and cross-platform capability.

The data collecting device 35 can be an automatic device or, as illustrated, can be a computer employed for the convenient collection of data or characteristics for elements by the representative 30. The data collection device 35 can be a combination of automated and manned devices.

It is understood that the data collection device 35 can also operate some of the application programs and maintain a database system similar to that described above for the server computer 20. Such application programs can manage a rule database for application to an element database to determine what characteristics are out-of-compliance. Where such determination is made at the data collection device 35, the responsible representative can quickly determine whether an element is out-of-compliance, right at the time of data entry. A server computer 20 would still be required to run the notification system 26 and preferably to periodically synchronize the entries in the rule database 24b and element database 22b. This localized capability is particularly useful in the area of point-of-care treatment where it is helpful to determine on site if the results being applied are meeting the standard or not.

Turning to FIG. 1b, an embodiment is illustrated that is similar to the embodiment of FIG. 1a, however, it includes the addition of additional responsible representatives 70, including a hierarchy of successive and superior responsible representatives 70,30. Typically, the successive responsible representative 40 is deemed responsible for remediation of a particular element when contacted by the notification system 26 of a non-compliance status. Should the successive responsible representative fail to rectify or remediate the compliance status then a further successive responsible representative 70, superior to the successive responsible representative 40 can be contacted by the notification system 26. The superior successive responsible representative 70 can be a different individual or employee from the initial responsible representative 30 who may have collected data representing the element's or elements' characteristics.

Compliance Management System—Operation

In more detail and with reference back again to FIG. 1a, the responsible representative 30 periodically collects data for characteristics of the elements and enters this data into the data collecting device 35. Data including element's characteristics is transferred or communicated to the server computer 20 for receipt by the data collecting system 22 and for storage in the element database 22b. Preferably the transfer of data from the data collecting device 35 to the server computer 20 is through a distributed network 50 such as the Internet, although other means of transfer, such as modem or media are possible.

The rule application system 24 is triggered by a triggering event such as by a change in the element database such as by the addition of new characteristic data, so as process the newly received characteristics. Examples of other triggering events are described below. Upon a triggering event, the rule application system 24 applies the rules in the rule database 24b to the data in the element database 22b and determine if any elements are out-of-compliance. Various rule application systems are known to those skilled in the art and will not be reiterated herein.

Once the rule application system 24 has finished processing the data, the notification system 26 notifies a responsible representative, such as the successive responsible representative 40, of the status of any elements that are found to be out-of-compliance. Upon receiving the notification, the successive responsible representative 40 preferably initiates a remedial or corrective action that may include instructions 60 to the first representative 30 to correct the situation.

An element's characteristic data may only be polled and input periodically. Accordingly, and preferably, the rule application system 24 is triggered to apply the rules in the rule database 24b to the characteristic data in the element database 22b by triggering events other than merely the presence of new characteristic data in the element database 22b. For example, the timing system 28 may periodically send an instruction to trigger the rule application system 24; the periodicity being regular or some other frequency including that based on element-specific timing.

Alternately, the rule application system 24 could be triggered by an event such as update of the rules in the rule database 24b. A change in rules may alter the compliance status of existing element characteristics. The rules can be reapplied to the data in the element database 22b and thereby initiate a reassessment of the status of the elements. Characteristics that were previously in compliance could be found to be out-of-compliance under the new rules or vise versa.

A person skilled in the art recognizes that the there are various embodiments of the compliance management system, the disclosed features of which may be operated in differing combinations, all of which succeed in directing an entity towards compliance to a set of rules. For example, as set forth, the rule application system 24 may be triggered by any of a number of different triggering events, or the entity may be made aware of the out-of-compliance status of certain elements through a variety of different notification means.

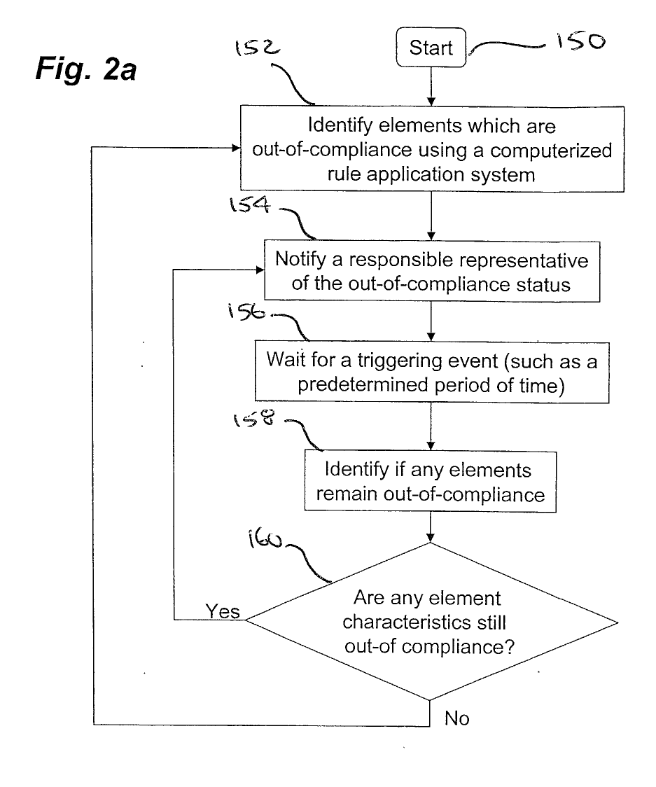

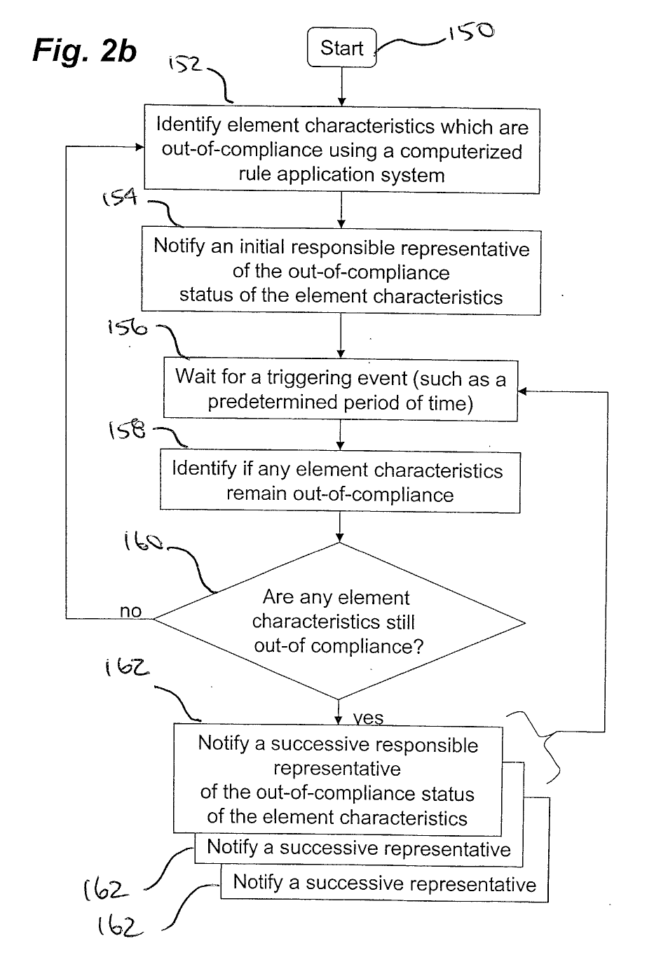

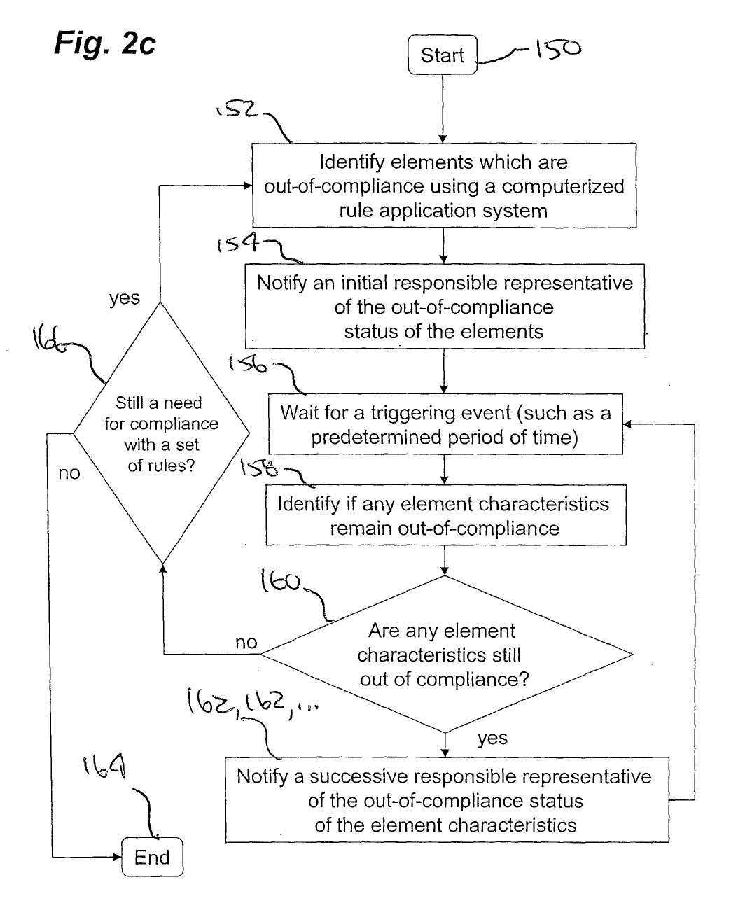

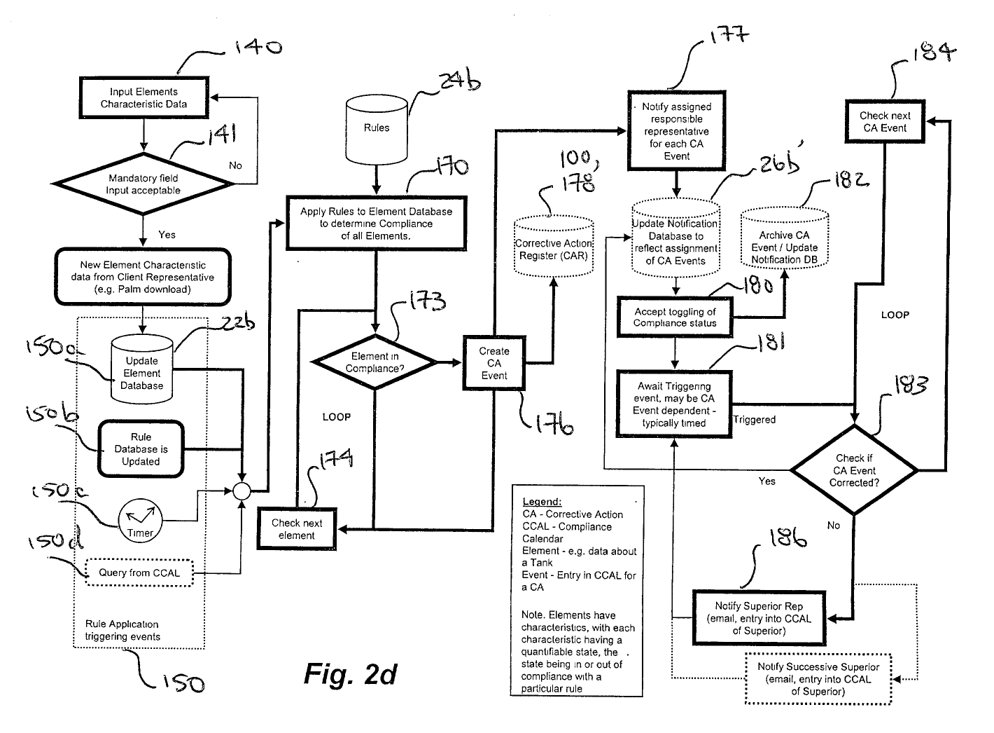

More specifically, and with reference to FIG. 1a and FIGS. 2a-2c, steps for directing entity compliance to a set of rules are shown. In FIG. 2a, once started 150 by some triggering event, the rule application system identifies 152 one or more, or a set of, out-of-compliance elements, preferably through an application of rules to data representing the state of the characteristics associated with the element. A responsible representative is notified 154 of any out-of-compliance elements. After waiting 156 for a subsequent triggering event, such as a predetermined amount of time, a step is applied to identify 158 which elements remain out-of-compliance. This may be through re-application of the rule application system or through a toggling of the status by responsible representative. If any of the elements remain out-of-compliance 160 then a responsible representative is again notified 154 of the remaining out-of-compliance element characteristics, otherwise the process ends, typically by returning to a triggering event and re-application of the computerized rule application system 150.

As shown in FIG. 2b, and preferably with each repeat, the responsible representative notified of a remaining out-of-compliance element is a successive and superior responsible representative 162 of the representative 154 or 162 previously notified.

In the embodiment of FIG. 2c, a needs step 166 is provided that determines if the entity is still in need being directed to compliance with a set of rules for a given element. If so, then the process repeats starting at the identification step 152 where the compliance management system starts the rule application system anew upon some suitable triggering event. If not, then the process ends 164.

Accordingly, the entity is directed into compliance in an effective manner by progressively notifying successive responsible representatives that an out-of-compliance status remains outstanding, upwardly within an entity's organization hierarchy, preferably notification being directed at a superior to the preceding responsible representative.

Compliance Management System—Assigning and Tracking of Duties

Having reference to FIG. 2d, in another more comprehensive embodiment, a rule application system is triggered 150 by a variety of alternate triggering events, including the updating of the element data base 150a, the updating of the rule database 150b and a query from a timing system 150c or a compliance calendar CCAL 105d. Preferably and detailed further below, the rule application system (FIGS. 1a,1b) is triggered to apply the rules in the rule database to the characteristic data by additional events including reports generated by an incident or a development in a personnel management system. The rule application system could be applied upon the earlier of any of the triggering events.

A responsible representative inputs data 140 for characteristics associated with an element. If no data is input or it is unacceptable 141, then the representative is prompted to re-input the data.

Upon a triggering event, such as the updating of element characteristic data 150a, one or more elements are identified as having an out-of-compliance status by the application 170 of rules 24b to the characteristic data in the element database 22b. The rule application system determines 173 whether the characteristic of an individual element and thus the element it self is in or out of compliance, and loops or repeats 174 this determination for the remaining elements. If the status of an element's characteristic is out-of-compliance, a corrective action event (CA Event) is created 176, and a responsible representative is assigned and notified 177. For example, a report generated by a personnel management system will update a characteristic for an employee that reflects the fact that he has failed a re-certification. A plurality of CA Events are stored in a corrective action register (CAR) 178, which itself is typically in a database format and that can be managed by a database management system on the server computer 20.

For the above employee, application of the rules, by the application program, to element database 22b causes a CA Event to be generated 176 and stored in the CAR 178 reflecting the fact that the employee certification status characteristic of the certification element, and thus the entity, is out-of-compliance because it employs someone who is no-longer certified.

Preferably the CA Event is an entry in the notification database 26b and that contains sufficient information to allow the compliance management system to assign and notify 178 a specific responsible representative and continue to track whether the CA Event has been remedied or corrected—indicating that the element is now in-compliance. More preferably, CA Events are time and date-stamped when first created and archived 182 in a database. Such time and date-stamping is useful in providing evidence of an entity's “due diligence” in the event that the non-compliance is associated with critical elements such as a regulatory offence.

When any of a element's characteristics and the element are out-of-compliance then a responsible representative is notified by the compliance management system and alerted to the fact that a remediation or corrective action must be undertaken. This notification 177 of a responsible representative 40 may be the same individual as the initial representative 30 who was assigned to monitor the particular element, or the notification 186 may be to a different individual 40,70. The notification 177,186 can be done in a number of ways, including automated faxes and emails, and direct uploading of the notification to the responsible representative's computer. In the case of an initial responsible representative, notification 177 could be directed to the data collection device 35 or in the case of the successive responsible person, notification 186 to their terminal 45.

Computerized notification systems are well known to those skilled in the art and can make their notifications in a wide variety of ways, including displaying the notifications on a screen, creating a printout, or sending an email. In a preferred embodiment the notification system 26 of the present invention is incorporated in the CAR 178 that includes, among other things, element or characteristics summaries, notifications and emails.

The notification 177,186 is accomplished by uploading the relevant portions of the notification database to a responsible representative's data collecting device 35, such as through a form application interface, or to other responsible representatives through various other electronic or media means. In the case where the data collecting device is utilized to receive such notifications, then this computer has two functional aspects: both data collection and notification of corrective actions.

More preferably, a combination of electronic read-receipt and digital signatures is used to authenticate the fact that the responsible representative did in fact read the notification. In yet another embodiment, electronic date-stamping can be used to keep records for further audit and due-diligence purposes. Such date-stamping, used in conjunction with the electronic read-receipts and digital signatures provides an entity with a good evidential record that notification of corrective actions were sent to the appropriate representatives, were received, and were read by those representatives.

Before triggering 181 an identification of elements having an outstanding out-of-compliance status, a response period is initiated for each CA Event, within which the responsible representative is expected to take corrective action and report back to the system. Preferably, if corrective action was taken, and the CA Event is remedied, a responsible representative toggles 180 the status of the corrective action event entry in the notification database from out-of-compliance to in-compliance. Due to the importance of correct 26b and timely remediation, preferably only an authorized representative is permitted to toggle the status of a CA Event in the register from out-of-compliance and back to in-compliance. Whether a representative is authorized or not is a matter of hierarchy in the entity's organization structure. An incorrect toggling of the compliance status may be caught at the next rule application.

Upon a triggering event 181, such as expiry of a pre-determined period of time, the compliance management system monitors 183 whether the corrective action event was corrected. This could be determined by re-application of the rule application system or simply by reading the toggled/untoggled status of the CA Event. If the event was corrected then the notification database is updated 182 to reflect the status and preferably the CA Event entry is archived for future reference. All CA Events are checked 184 in a loop. If the corrective action event was not remedied by the next triggering event 181 such as the specified period of time, then a successive or superior of the responsible representative who was initially assigned the event is notified 186. Preferably, and upon the failure of each representative to take corrective action, then a successive responsible representative, superior or supervisor is notified 188, and so on, up the management hierarchy.

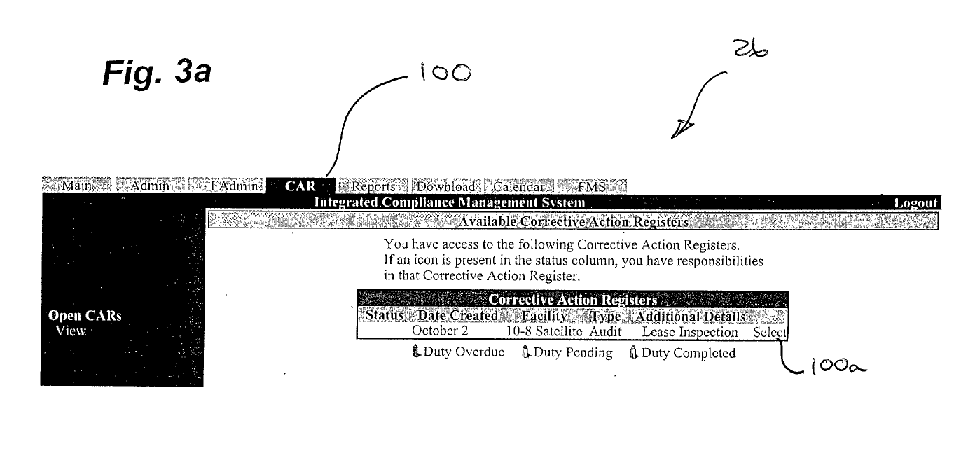

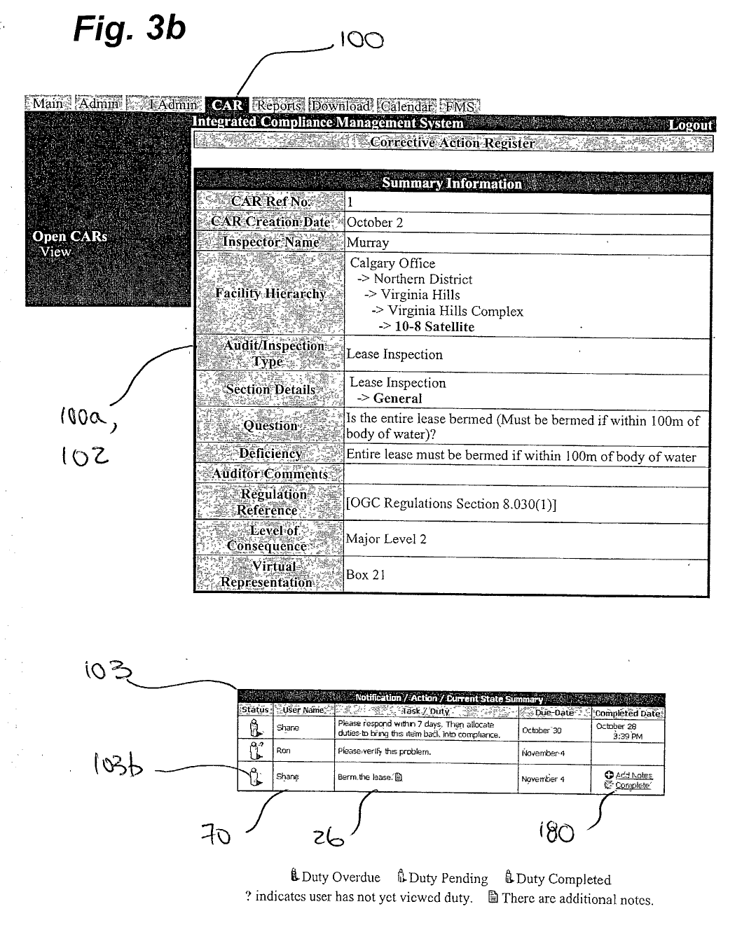

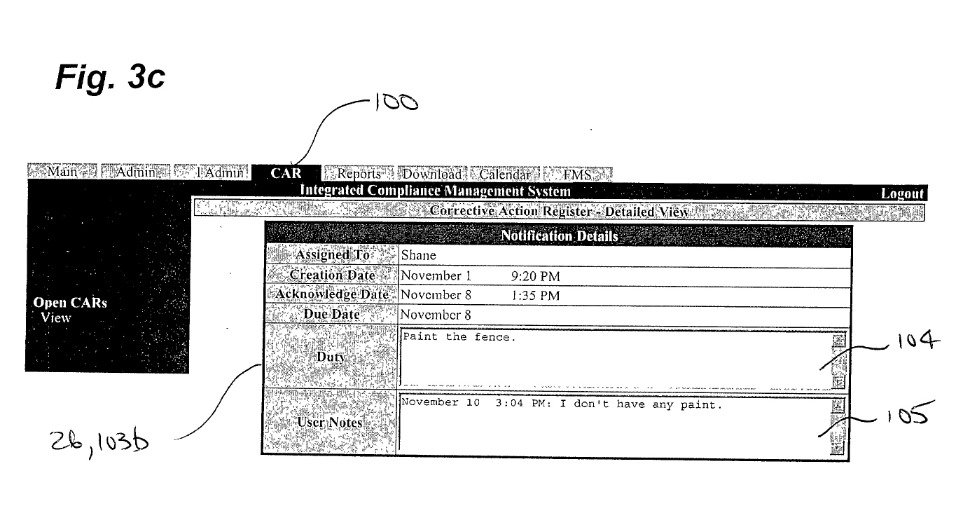

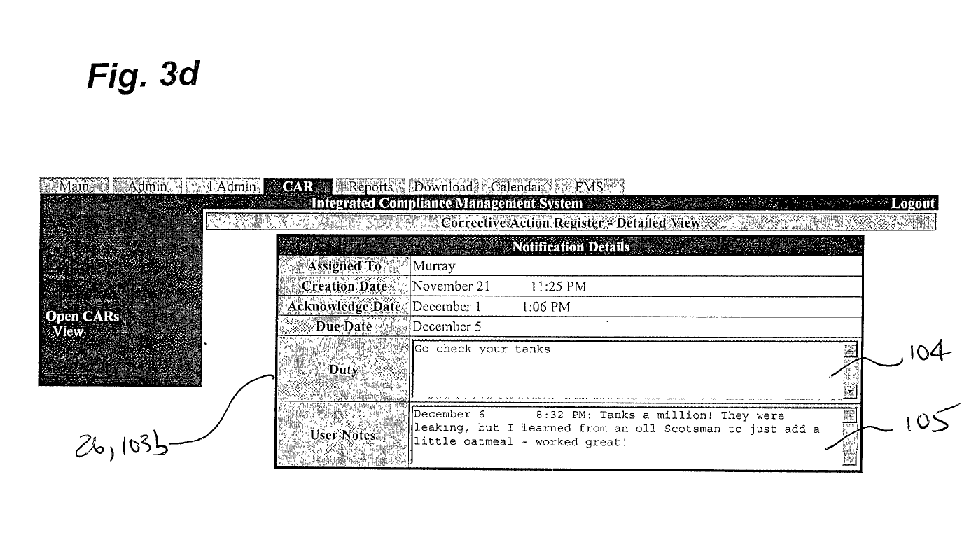

Preferably, the notification 26 and the toggling 180 of a compliance status can be effected through an interface to the corrective action register CAR 178,100. Turning to FIG. 3a, a screen-image shows one available CA Event in the CAR 100; in this case for an entity-initiated polity for condition a lease inspection as part of an audit. The subject lease includes a hydrocarbon facility named “10-8 Satellite”. As illustrated, the CA Event was created on October 2^{nd} and is overdue or out-of-compliance. The duty, element or CA Event is the lease inspection. Through an interactive interface with an authorized or responsible representative, such as a clickable hyperlink “Select” 100a, more information about the element is available as shown in FIG. 3b.

FIG. 3b is a screen-image of detailed information as a summary 102 for the specific facility and further illustrates various notifications 26 (three specific notifications shown 103 that are the responsibility of two different representatives 70). The specific notifications 103 are generated by the CAR 100 for elements that are out-of-compliance including a need for a containment berm about the facility for the containment of leaks. A hyperlink “Complete” is available for enabling toggling 180 of the completion to bring the element status in-compliance. The status and notification details 103 are available through a hyperlink symbol 103b for the representative.

FIG. 3c is an example of a screen-image of a detailed view of the status and notification details and a specific notification 103 in which the responsible representative provided feedback that they were unable to take a specific corrective action to upgrade some painting and therefore were unable to remedy the out-of-compliance status because there was no paint available. If the representative does not obtain paint and correct the deficiency, then subsequent application of the rule application system will identify and re-notify that representative or a successive responsible representative who has the authority or responsibility to compel compliance. The duty is clearly laid out 104 so that the responsible representative is clear on the requirements for compliance. A notes section 105 enable feedback to be recorded.

FIG. 3d is an alternate scenario illustrating a screen-image of another specific notification 103 wherein a duty to check the tanks 104 and corrective action was successfully undertaken to fix a leak, per the notes 105.

Returning to FIG. 3b, through a “Complete” hyperlink 103a an authorized and responsible representative can indicate their concurrence that a CA Event has completed in advance of a reiterative application of the data collection and rule application system.

While a responsible representative may access the CAR directly, a further convenient interface is through a compliance calendar CCAL interface.

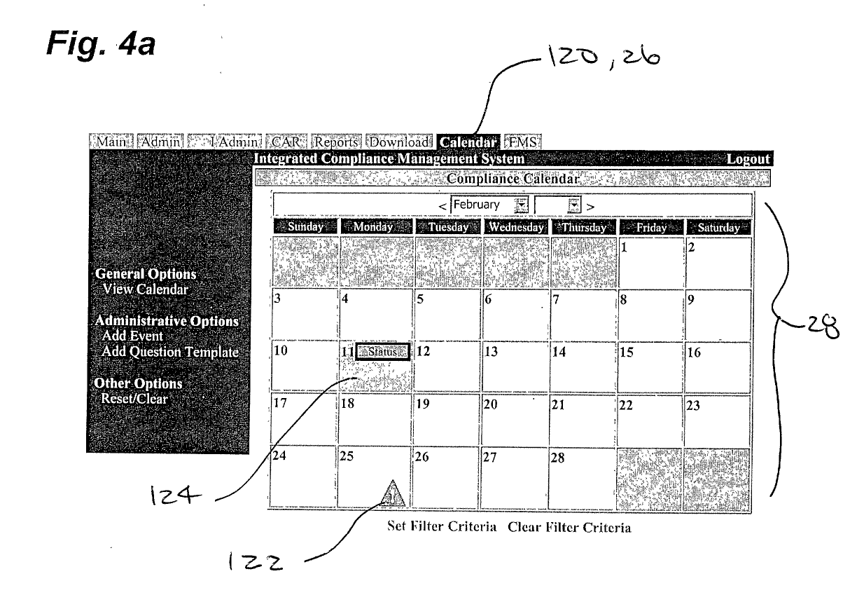

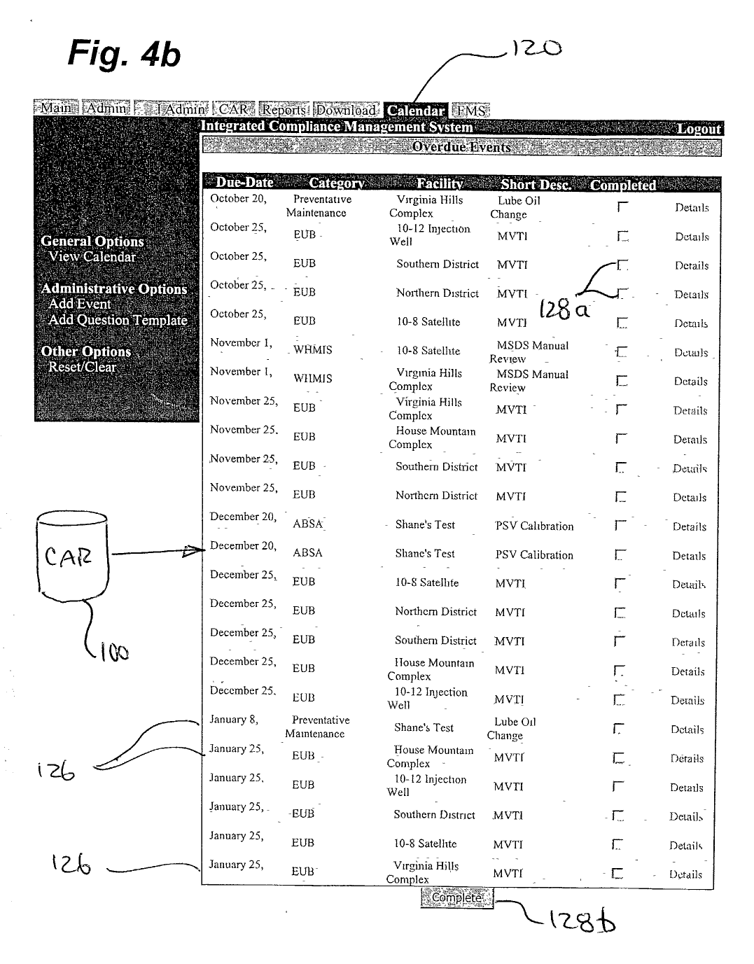

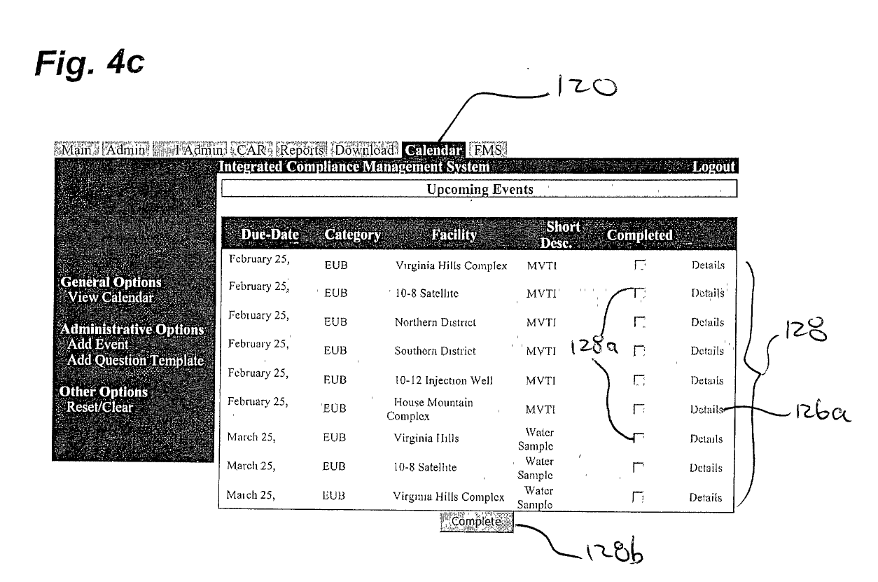

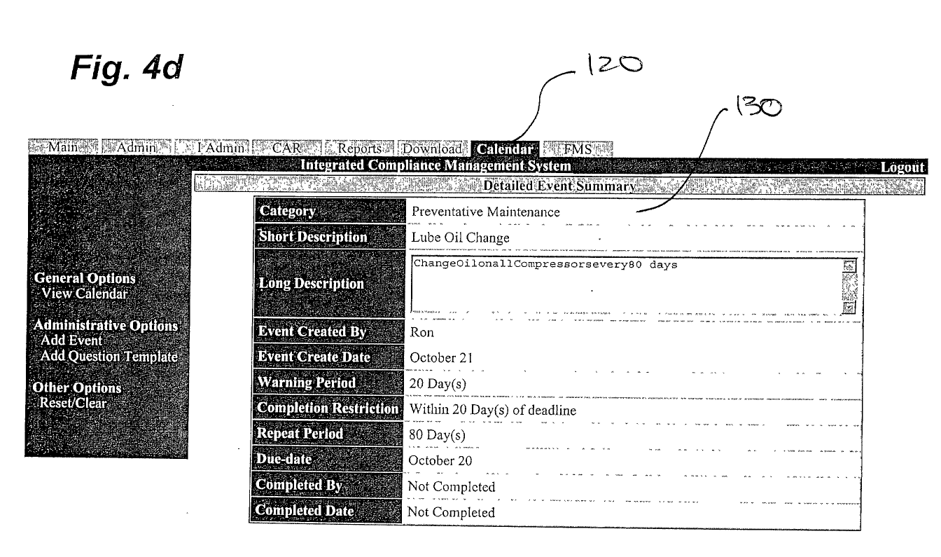

With reference to FIGS. 4a-4f, a CCAL interface 120 enables effective monitoring of the CAR 100. This is an intuitive system for identifying elements that are out of compliance and that are typically associated with a limitations date, duration or period that is conveniently represented in a calendar format. Turning to FIG. 4a, the notification system 26 of the preferred embodiment further incorporates the concept of the CCAL 120 which, among other things, is a convenient form of displaying the status of a plurality of elements. Preferably, the CCAL also incorporates components of the timing system 28 so that it can function as a true calendar and also act to trigger the rule application periodically. FIG. 4a is one embodiment of a CCAL 120 showing alerts 122 and status flags 124 for the month of February. The CCAL 120 provides an easy to read graphical display and descriptions of current CA Events. A legend can be selected using intuitive color schemes—red or an exclamation mark indication an out-of-compliance status. The CCAL 120 is filtered to tailor the status and alerts information to the particular representative based on criteria provided by the entity.

The CCAL interface 120 enables access to detailed and various forms of notification 26 of CA Events 126 (FIG. 4b) and notification 26 of upcoming compliance requirements and data collection events 128 (FIG. 4c). The responsible representative, if so authorized, can indicate a change in the compliance status through appropriate checkboxes 128a in the “Completed” column and then clicking the “Complete” button 128b, or by awaiting the periodic application of the rules and current characteristics data for the particular element. Through “Details” hyperlinks 126a, the responsible representative can obtain detailed summaries of a CA Event 130 the result of which is shown on FIG. 4d.

With reference to FIGS. 4e and 4f, the CCAL can also serve as an interface for adding rules or CA Events. The rules may include manual addition of rules imposed by regulatory agencies such as Occupational Health and Safety (OH&S) and the Alberta Energy and Utilities Board (EUB), or those set by the policy of the entity. Policy-based events are those that typically exceed regulatory, third party imposed rules and serve a particular purpose to the entity such as to apply preventative maintenance measures. Some typical fields include element type, element characteristics, compliance rules and assigning responsible representatives. FIG. 4e lists one example of CA Event templates 132 that provide convenient input guidelines for the various fields tailored to each regulatory agency or entity policy. FIG. 4f illustrates some of the field options for the addition of an event.

Authentication of an authorized responsible representative can be accomplished through a digital signature means. For example, a digital signature from the authorized representatives data collecting computer will be downloaded to the server computer, after the subsequent data collection event, and will trigger the application program to automatically toggle the status back to into compliance (should the new data be found to be in compliance with the rules). Other means of authentication include the verification of the representative's individual digital profile.

Further, an entity may designate additional authorized representatives to access the notification database (through the CAR or CCAL interface) to check for any such flagged characteristics.

Mandatory Element Data Collection

Where the characteristic data of one or more monitored elements is gathered using an autonomous data collection device, there is no need to ensure that proper characteristic data is gathered—other than to ensure that the device is working properly and is calibrated correctly (that in turn may trigger a second level of compliance management).

However, where one or more responsible representatives of the entity are assigned to particular monitored elements and are made responsible for the periodic collection of element characteristic data, it may be the case that some of the representatives are not motivated to collect all the appropriate data or that they are not adequately informed of what data to collect. Therefore, as shown in FIGS. 1a,1b, the representative 30 is preferably equipped with a data collecting device 35 that implements an application that demands the collection of specified characteristic data that is mandatory to qualify before an in-compliance status can be determined. Preferably, the data collecting device 35 is capable of interfacing with the server computer 20 of the management system 10 through an interactive digital connection 50 such has a network connection. Alternatively, information can be exchanged between the data collecting device 35 and the server computer 20 using recorded media, an infra-red communication connection or through other means.

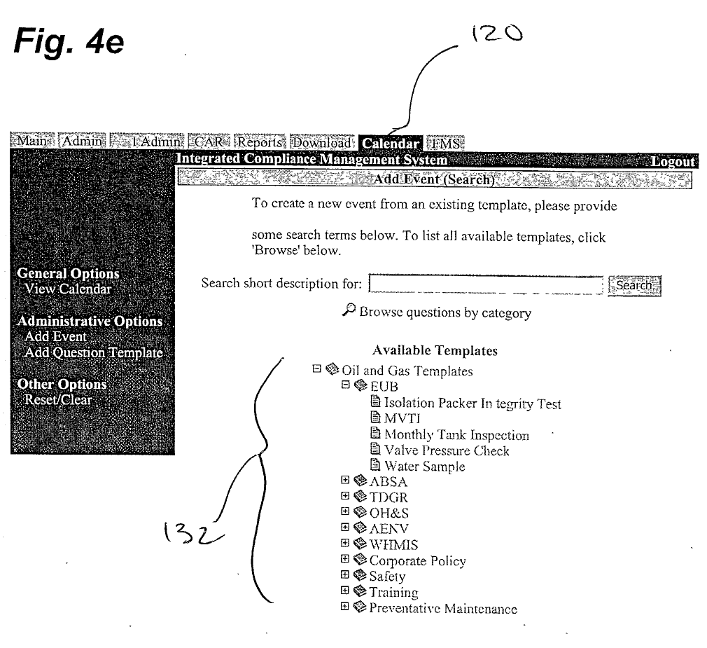

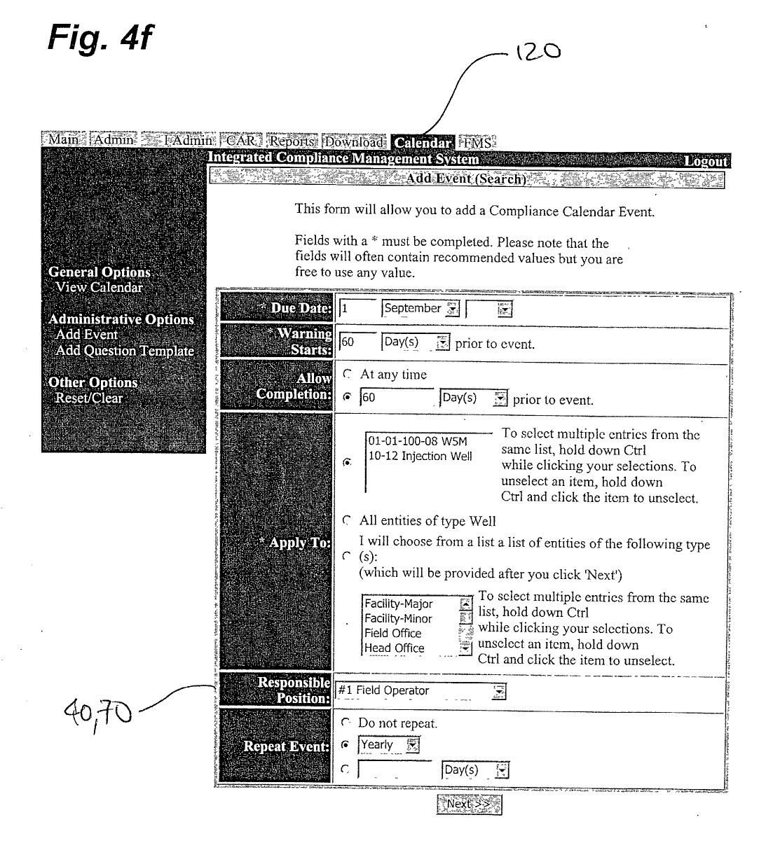

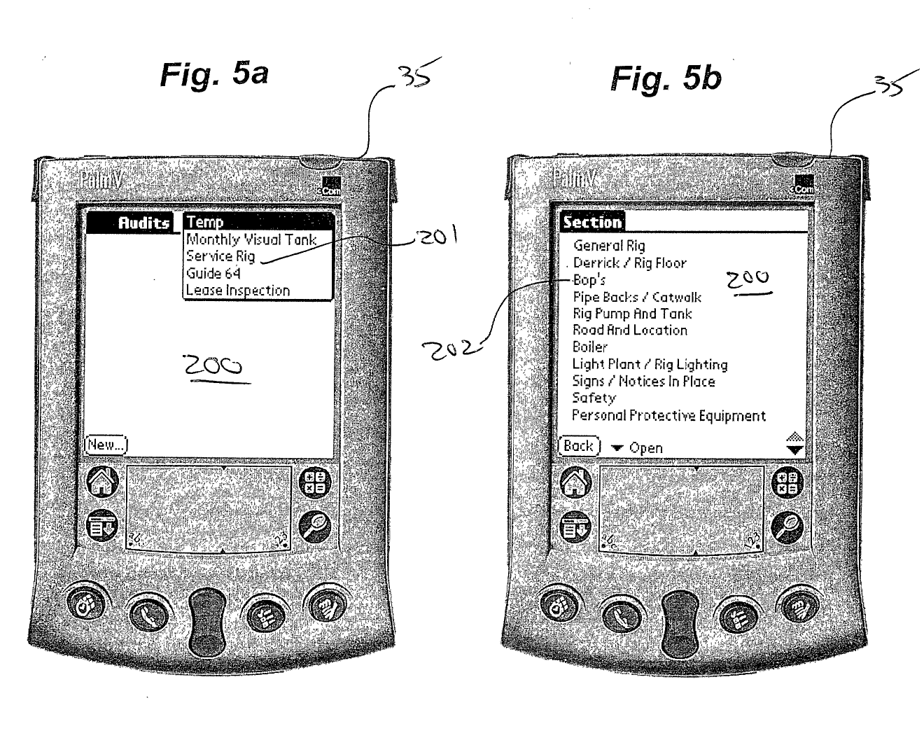

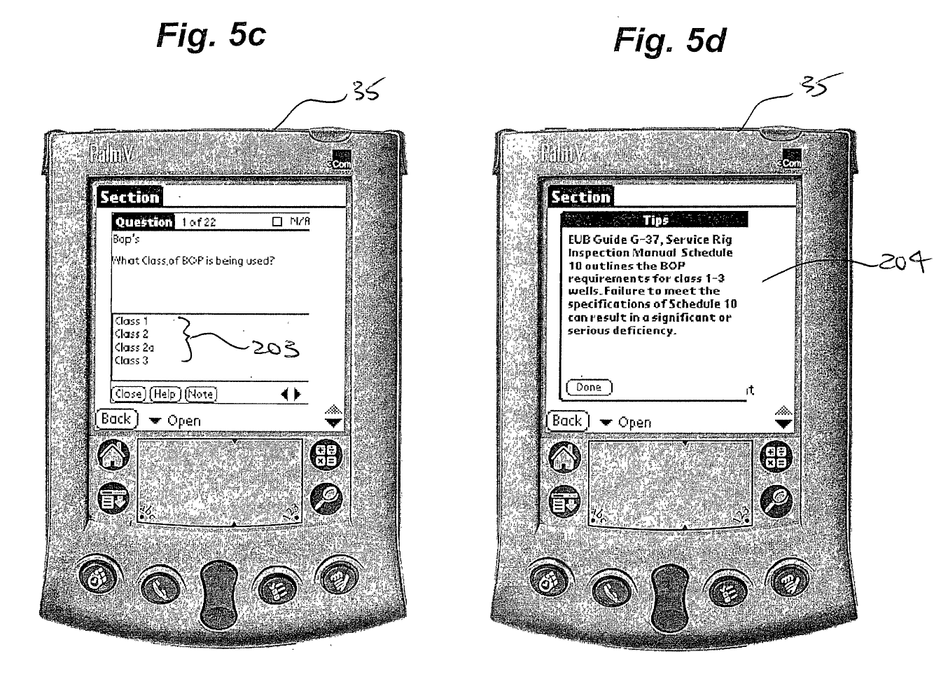

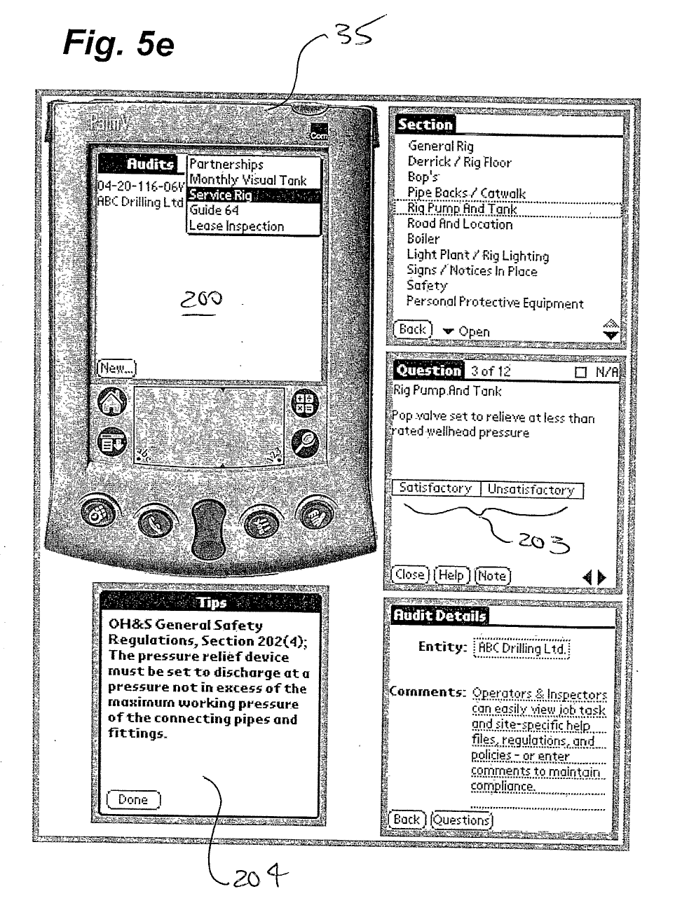

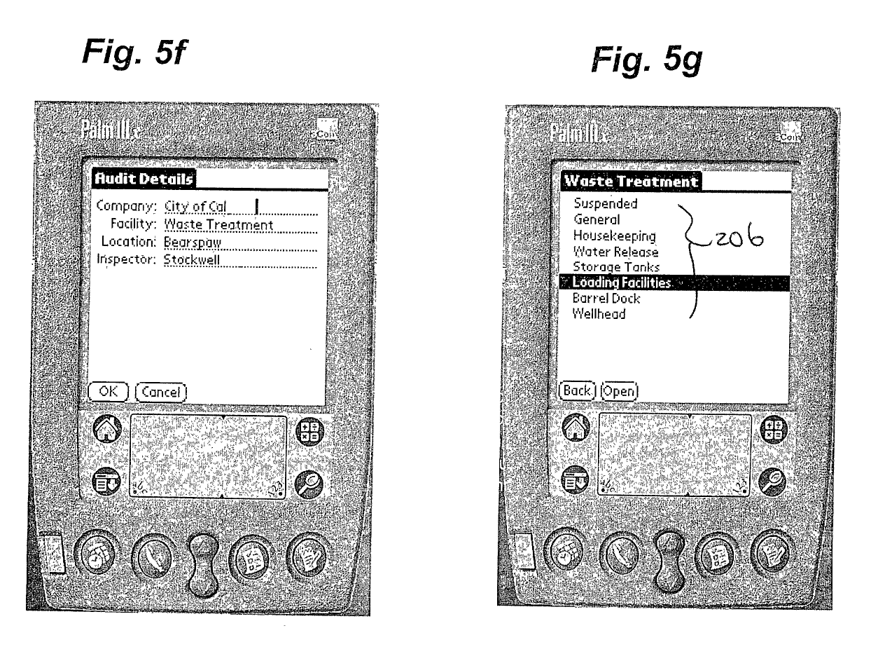

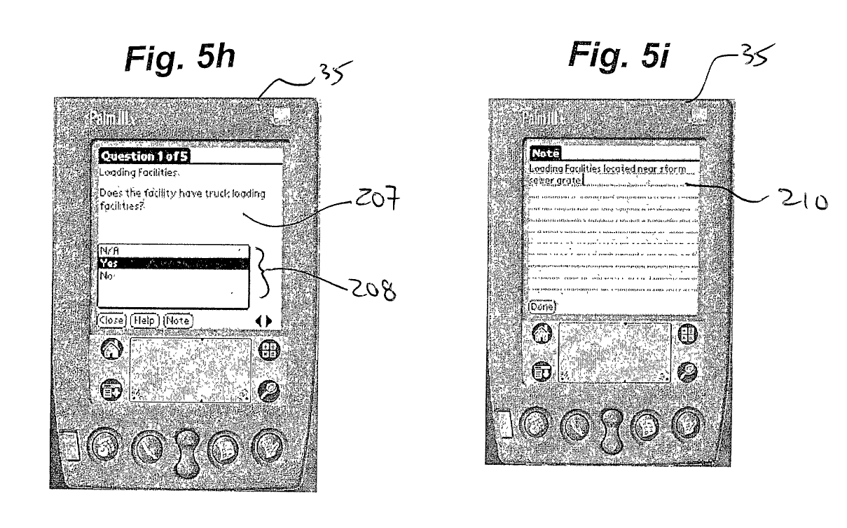

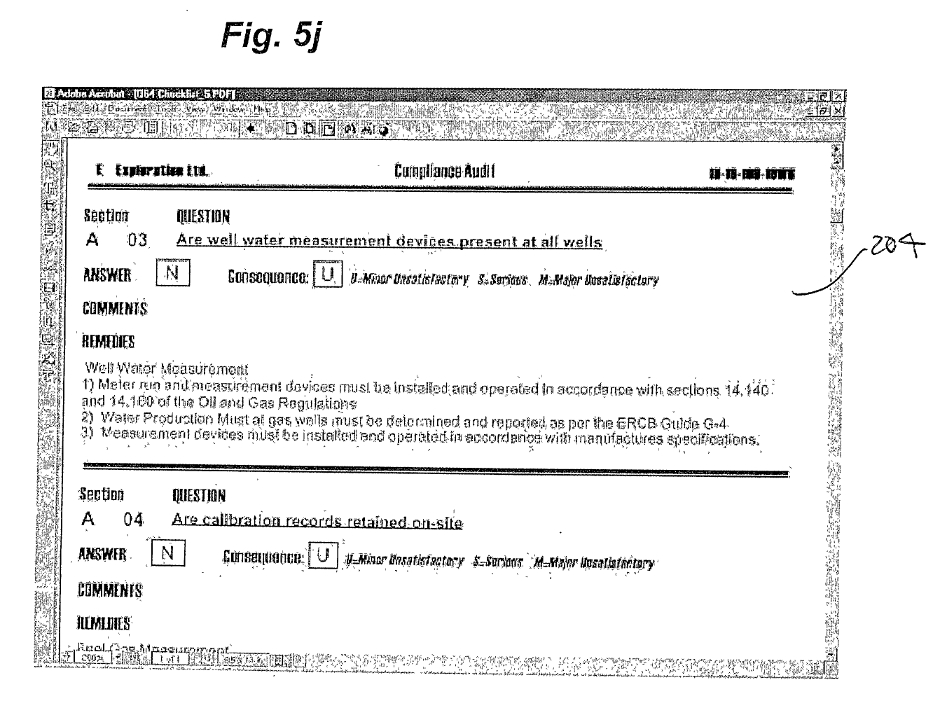

With reference also to FIGS. 5a-5i, an example of a data collection device 35 is illustrated implementing a mandatory dynamic form application 200, operative to prompt the responsible representative 30 for data characteristics of the elements. A dynamic form may be created through Palm OS™ application development means and be operative on a Palm™ PDA or similar device operating the Palm OS™. In FIG. 5b, a selection of possible areas are listed including a service rig 201. In FIG. 5b, elements are listed from the selected area. One such listed element is a blow out preventor BOP 202 that is safety apparatus associated with a wellhead.

The representative 30 is compelled to properly complete the form application 200 before the application will allow any of the data to be transferred to the server computer. Proper completion may involve entering yes/no data values, quantifiable values or textual information. Further, proper completion of the form can include a check to ensure that the data values are actually entered (no blank fields), or that data values are within a certain range. An improper completion of the form will cause the form application 200 to reject the data characteristics inputted by the representative. Such a rejection may be in the form of an error message and a prompting for proper completion.

As shown in FIG. 5c, the form application 200 may alternatively prompt the representative to select from a list 203 of characteristics having a limited number of data characteristic quantifications, and will simply wait until the representative makes a selection, thereby ensuring that the form is properly completed. For example, the representative is prompted to input the class of BOP that is being used. The representative is also provided with one of four alternative answers 203, those being Class 1, Class 2, Class 2a or Class 3. Therefore, for the representative to properly complete the form, they must select one of the four alternatives before proceeding to the next prompt or completion of the form.

Turning to FIG. 5d, as an assistant to the representative 30 in providing correct characteristic data (e.g. which Class) for each element (e.g. a BOP) in the form, during the operation of the form application, various fields in the form can be associated with help information 204. For example, the form 200 informs a representative that EUB Guide G-37 outlines the particulars for each of the BOP classes and what they are—to assist the representative in identifying the appropriate class of BOP. FIG. 5e provides a further illustration as applied to an oil field service rig's rig pump and tanks, having characteristic data for a safety valve being either satisfactory or unsatisfactory, a help component aiding in the compliance criteria being at a pressure “not in excess of the maximum working pressure.”

With reference to FIGS. 5f-5i, another embodiment of a dynamic form 200 is shown that illustrates additional means for compelling proper completion by a representative 30. A representative begins a session of the audit details component and enters the specific facility information (FIG. 5f). The representative is then prompted to select which element 206 for the facility the representative would like to complete (FIG. 5g). Each element or section of the form is associated with a set of questions that are displayed a page-at-a-time, prompting a yes, no or n/a response 208 (FIG. 5h). Proper completion is encouraged or compelled by not allowing the representative to continue with the set of questions until one of the displayed answers is chosen. Preferably, the representative can add optional notes 210 along with each response (FIG. 5i). These optional notes 210 are preferably text entries. The optional notes 210 could also be sketches and scribbles (converted to a digital graphic file) or digital photographs. The optional notes 210 would not likely be subject to direct and subsequent rule application, but would be useful for future auditing, archiving, data collection purposes and as additional descriptive data for display in the corrective action register.

As demonstrated in FIG. 5d and FIG. 5j, reports, help and online checklists 204 are also useful in instructing a representative about the applicable rules, elements and consequences of the compliance status. The online help, reports and checklists 204 are tailored to the device and the representative used to access the information. FIG. 5d is illustrative of a checklist tailored to a portable device 35 and FIG. 5j is typical of more comprehensive source of information available on a terminal or computer interface.

The dynamic form application 200 itself, and any help information 204, are updated periodically. This updating is what makes the form application 200 dynamic and ensures synchrony between the collection of characteristics data and the rule application system. Preferably this is done during the transfer of the data to the server computer by concurrently transferring any updates from the server computer. Preferably, this is done without need for conscious initiation by the representative. Alternatively, this is done through periodic updates provided via recordable media, infra-red communication or other means.

More preferably, the data and form 200 on the data collecting computer is automatically and periodically synchronized with the data and form on the server computer. In this way, the form application is up-to-date without need for the representative to deliberately monitor the updating process. If the rules for an element have changed, the dynamic form application 200 changes and any help 204 associated with the changes characteristic is similarly updated. Such changes are applicable to at least the entity elements for which the particular representative is responsible.

Accordingly, compliance is compelled through collecting mandatory element characteristic data, utilizing a rule application system to identify element characteristics having an out-of-compliance status, assigning a responsible representative to perform certain corrective actions and notifying a hierarchy of successive responsible representatives if the previous responsible representative has failed to take the requisite corrective action.

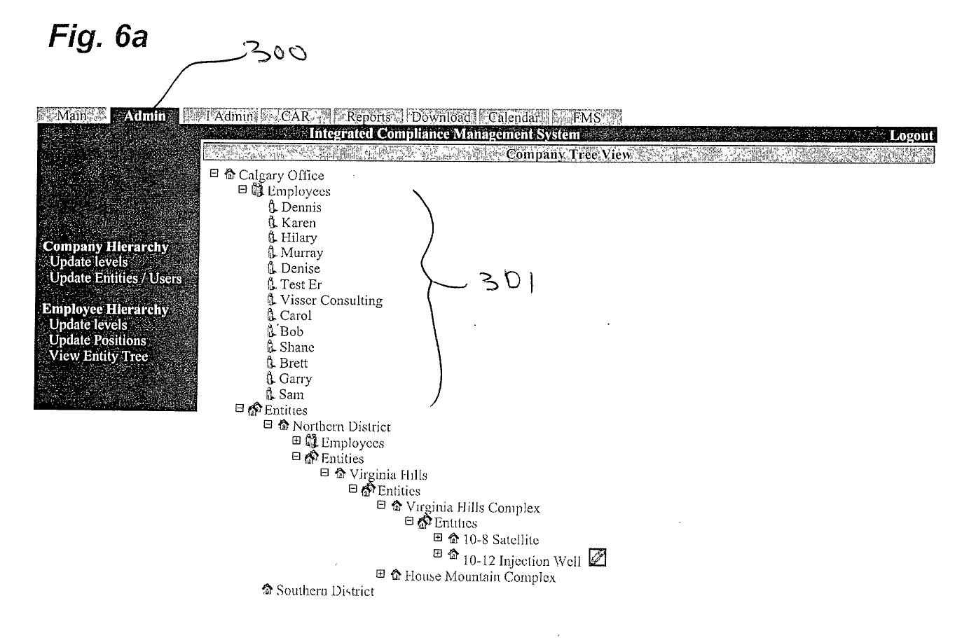

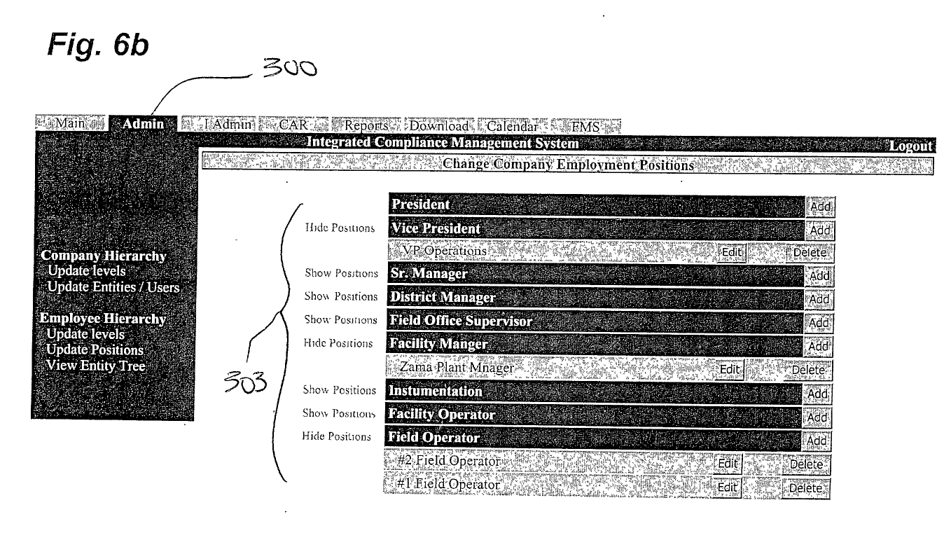

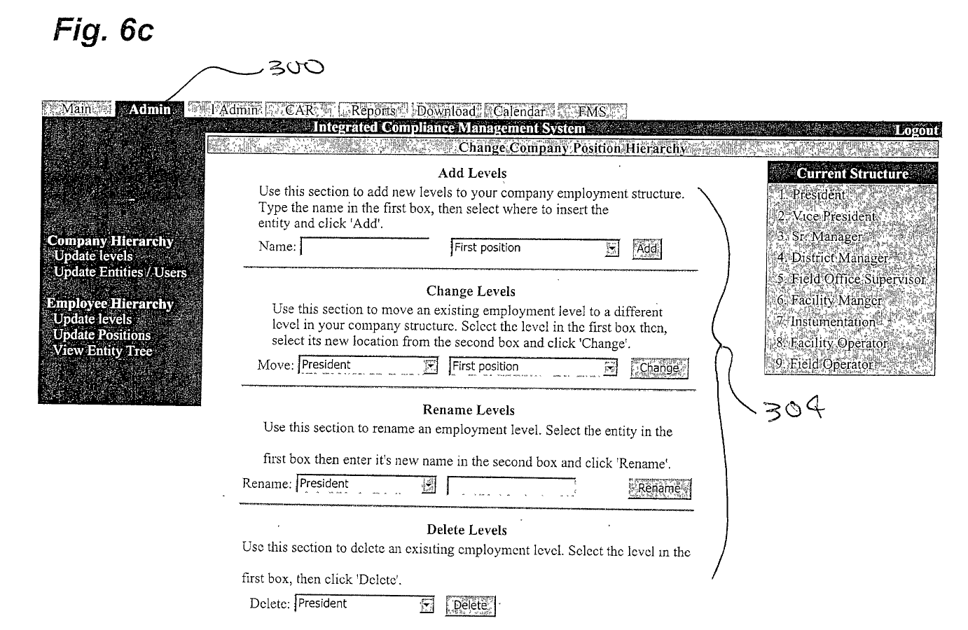

As shown in FIGS. 6a-6c an administrative operator, such as a responsible representative having sufficient authorization, can access 300 and view 301 a hierarchy for an entity (FIG. 6a). Further, as shown in FIG. 6b, the representative can edit an entity's company positions 303 (FIG. 6b) and edit the hierarchy 304 (FIG. 6b).

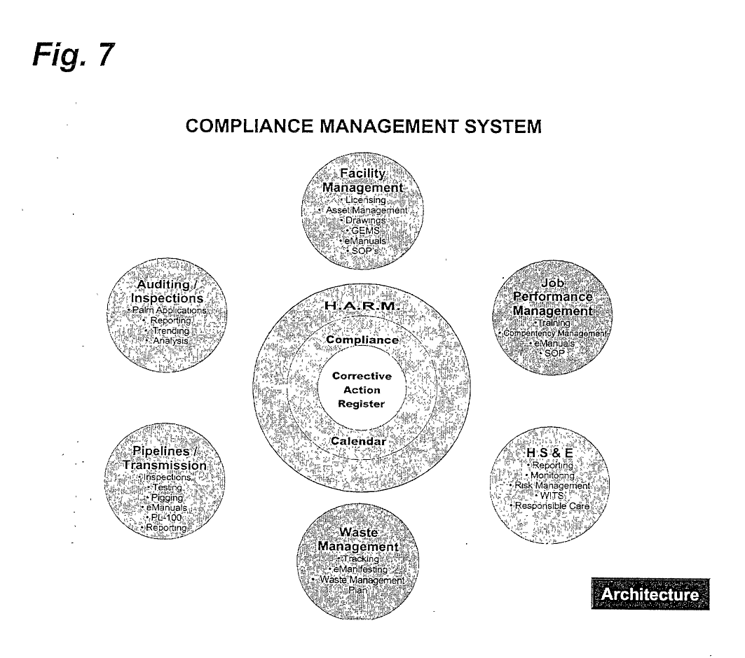

With reference to FIG. 7, and to several preceding figures as the context suggests, a compliance management system is illustrated comprising a compliance calendar and corrective action register as being central for the management of an entity's operations concerning the entity's hydrocarbon production facilities. As shown, the system integrates compliance management with aspects of personnel management, workplace safety and incidents tracking, and elements of the particular facility and its elements. As set forth in part above, the CCAL provides all identified system users in a company with a graphical display of required compliance items. The CCAL provides descriptions of upcoming events, notification of overdue events, and provides links to relevant help and training information. As described above for FIGS. 3e and 3f, the server computer provides compliance events in the form of “templates” to the entity. These templates define required compliance events. The entity then takes the template and applies it to their company. For example, a template can be provided describing the required Monthly Visual Tank Inspection, which template also provides a recommended implementation procedure. An entity can then select the template and apply it to their company by creating a due date and a notification period, listing responsible people, and posting it to their calendar. FIGS. 3a-3f illustrate screen-images of different levels in one embodiment of a CCAL interface for displaying the compliance status of a plurality of elements.

The CAR is a project management tool that applies business rules to the data collected by the compliance applications. The business rules identify all non-compliant elements requiring corrective action. Each corrective action is assigned to a responsible person and tracked in a project folder until completely remedied. To close the action item, CAR then accepts a digital signature from an authorized individual and archives the results for possible future reference. CAR also creates an audit trail that outlines the entity's steps taken to remedy a non-compliant element. FIGS. 2a-2e illustrate screen-images of different levels in one embodiment of a CAR report.

The compliance management system is further enhanced using complementary modules for further integrating management of safety and personnel concerns.

A hazard assessment risk management module, or HARM™, is a software-supported process that combines an identification of hazards and risk assessment as an element of an integrated health, safety and environment management system. The process includes the step of assessing tasks and documenting the hazards associated therewith. HARM guides the responsible representative or user through the logical steps required to determine risk rating levels for worker health and safety, environmental, equipment, production and community issues. HARM can identify elements that may be subject to regulatory rules or would be preferably added voluntarily to the compliance management system as monitored elements as part of the entity's policy.

Hazard identification and risk assessment are the fundamental building blocks upon which any effective health and safety management system are built. The essential steps of assessing all operations in the workplace, to identify key hazards associated with tasks and then assessing and mitigating the risks, are critical to eliminating injuries and costly workplace incidents. Efforts taken to identify, assess and control all significant risks pay off, not only in managing the entity's compliance with the applicable rules, but also has benefits in reduced costs relating to worker injuries, environmental or equipment damage, production down time and community relations issues. A hazard identification database is established for detailing elements such as hazard type and details, and an assessment of a hazards severity including for example: for personnel, being between trivial to fatal; and for an environmental hazard, being between slight to massive with major public concern and involvement. Typically the details of the hazard include control measures that may become compliance elements. Additional fields or factors can include an assessment of the probability of an occurrence that the specified hazard may result in injury or equipment damage.

A workplace incident tracking system or WITS™ is another component of an integrated health, safety and environment management and compliance management system. WITS tracks and documents workplace health, safety and environmental incidents, investigations, root causes, and preventive action, the background for which can be readily accessed from the system of databases. Preventative actions are an example of useful elements that can be incorporated into the compliance management system. Due to the specific nature, the format of each WITS is tailored to each entity's needs.

A job performance management system is another component that manages personnel and can be integrated with the compliance management system. Additional compliance effectiveness is achieved by monitoring the personnel in the entity's organization and matching personnel as elements and their characteristics such as qualifications or certification status against criteria such as minimal supervisory requirements and job descriptions, thereby assigning optimal personnel thereto. By collecting quantifiable data about an employee's characteristics (e.g. the employee is an element, having quantifiable characteristics, in the database system) the compliance management system can be used, not only to determine if an entity's employees (and their level of training for example) are within compliance, but also to provide the building blocks of an overall management system. The system is used by entities to define, track, and manage skills and tasks required in the workplace, and to provide administrators and workers with easy access to job profiles, progression training requirements, and performance assessment information.

Administrators combine hazard assessment and risk management components with job performance management to profile job duties and activities in order to ensure the necessary mitigation elements (employee orientation, training, safe operating practices, hazard identification) are in place to protect the worker, the workplace, and the environment. The core features include human resource development; job profiling; training calendar; performance tracking; site-specific SOPs and critical task checklists; training guides and assessment tools; contract operator management; safe work permits, incident tracking; HARM; hazardous task assessment; process hazard identification; risk assessment and mitigation; critical performance support information; task-specific regulatory and legislative content; corporate policies and procedures; and manufacturer/fabricator operator manuals and procedures.

A quality assurance manager (QAM) operates in conjunction with the compliance management system and enables critical content management for the creation, management and delivery of critical performance support information. In the context of compliance management, the effectiveness of a representative in his responsible task for a specific site is greatly enhanced with the right tools; both physical tools and knowledge tools. While a QAM has applicability in a broad range of information management functions, it is particularly well suited for aiding in identification of compliance issues and corrective actions. QAM provides proactive support to representatives and provides improved access and revision control over traditional paper-based methods. QAM is a database-driven authoring tool that is available and integrated with CAR and CCAL. A QAM is a reference for procedures that are too critical to be left to rote memory of the individual representatives. For instance, in responding to a CA Event, and where a representative has a responsibility level that covers both hazardous and non-hazardous facilities, and the representative has a particular skill set and job description, then QAM tailors the information to be site specific and provide task-centric critical content for the facility and that responsible representative. Further, the QAM archives and formats experience for historical and related CA Events, thereby building the knowledge base and disseminating this knowledge to responsible representatives in the future.

### EXAMPLE 1

Hydrocarbon Production Facility

A preferred embodiment is set forth herein with extensive reference to management of hydrocarbon production facilities regulated by a supervisory agency such as one or more regulatory boards and governmental bodies. Some the materials have been provided earlier in the detailed description. Each industry has its own set of governing regulatory agencies. For instance, the system described herein is equally applicable to medical environments (including health care), occupational health and safety, animal husbandry, manufacturing, aircraft servicing, transportation, mining and forestry, to name a few.

In the case of hydrocarbon production facilities, a facility operator may manage one or more well sites. The facilities typically operate with hydrocarbons under pressure that are a potential environment hazard and in some cases can be highly toxic. The operations are subject to various environmental, emission and production regulations. In the hydrocarbon industry in Alberta, Canada, a relevant regulatory agency includes the Alberta Energy Utilities Board (EUB). In most instances, the EUB requires facility audits. A typical well site or facility can include oil tankage, flare stacks and water collection.

Such EUB audits can include a Major Audit—EUB Guide 64 Equivalent or a Minor Inspection—Subset of Guide 64 and Guide 58 and Guide 55.

More particularly, an aspect of operations or an element of an entity's facility is an on-site storage tank. Such a storage tank is an element that is found among the reference elements in the database system. Accordingly there is at least one rule associated with such tanks. A characteristic of the entity's tank element is whether it is leaking or not. A rule applicable to the entity's tank element is that periodic visual tank inspection must be performed monthly to be in compliance with EUB Guide 55 regulations.

In one embodiment of the invention, a facility operator will assign a representative to be responsible for one or more facilities. A responsible representative inspects the facility and reviews a checklist. In order to avoid missing critical data that is characteristic of the facility, a form is applied. The form introduces or reminds the responsible representative of each characteristic data that must be inspected, measured or otherwise reviewed. This form is an application operating on a data collection device such as a personal digital assistant (PDA), an example of which is a Palm™ (provided by 3-Com) or other electronic interface such has a laptop computer. A form application is operated that prompts the representative to enter field data. The data entry can be facilitated using hardware components including a portable keyboard, bar code scanners, digital cameras, global positioning systems (GPS).

The form application comprises one or more mandatory fields that must be filled. Once the field data is collected, it is uploaded to the server. Suitable means includes wireless cellular digital packet data, analogue telecommunication lines such as facsimile phone lines, or other established communication networks such as TCP/IP. If one of the fields is a compliance characteristic, then the representative must be authorized to alter the field data that, in turn, could affect the compliance status of the facility. The PDA can include a digital signature so that the entity representative making the change to the field data is identifiable and verifiable as an authorized representative.

Referring to FIGS. 5a-5j, a further example of the detail provided in various implementations of the data collection device and form applications is illustrated. Applied once again in a hydrocarbon production facility example, a well-site inspection application is expected to meet the intent of specified Oil and Gas Conservation Regulations, Guide 55, Guide 58 and others. The results of the inspections are reported by the server computer to authorized representatives or users. Users may perform audits and reports. Samples of elements include a monthly checklist for surface casing vents and the operability of high/low pressure switches. A typical drilling rig inspection application has fields based on the current Canadian Association of Oilwell Drilling Contractors (CAODC) drilling rig inspection form, and includes additional and preferred fields and content provided by an entity's own expert. Limited answers are available to compel the responses. As shown in question 1 of 22 in Section BOP's—users select answers from pick lists. The application allows users to add comments at each question. Each question has help text available (FIG. 5d), explaining regulations, Company Policy, additional elements to review, etc. to help them complete the audit accurately. When the EUB releases a new Drilling and Well Servicing Inspection Manual, the content in this application is updated to include any new inspection requirements.

### EXAMPLE 2

Laboratory

Established standards of acceptable performance are often monitored for elements having characteristics that must be checked at established frequencies. For example, maintenance of equipment such as a refrigerated centrifuge requires that the timer, the thermostat and the rpm be monitored, each at predetermined intervals, and that the results or quantitation for each fall within acceptable ranges.

A first level of compliance, performance, is maintained when each of the tasks is performed according to the preset schedule. In other words, an entry has been made for each of the characteristics within a preset timeframe. Should an entry not be made within the specified period of time, status is stored on an out-of compliance register and a flag is sent to the responsible representative indicating an out-of-compliance status. When the task is performed, an entry is made to the out-of-compliance register and is accepted only when entered by an authorized representative, typically identified by a digital signature.

A second level of compliance, acceptability, is determined by comparing the quantitative values entered against the specific rules in the rules database governing those characteristics. If all of the values fall within the established tolerance limits then acceptability is achieved and the system records the values and indicates that they were acceptable. If any of the values falls outside the tolerance limits an entry is stored on the out-of-compliance register and a flag is sent to the responsible representative indicating that the value falls outside tolerance limits.

Audits should allow for entry of text to record what corrective action was performed and not simply that a value meeting specs is now entered. It should allow for text entry of comments such as “had compressor replaced” or “had timer repaired as time interval was outside upper end of acceptable by 30 seconds” For some accreditations it is not acceptable to simply provide a subsequent acceptable result performed within a preset period of time.

In another aspect, quality control material is typically analyzed in 2-3 ranges for each analyte and the values compared to established tolerance limits. Depending upon the technology, the intervals vary, i.e. requirements may be “with each assay” for batch analysis particularly for non-linear analyses or “once per shift” for more robust linear analyses. Quality control should also be run each time there is a lot number change for any reagent used in a particular analysis. The results for each QC material are compared against established tolerance limits. Guidelines may be provided by the manufacturer in the case of “assayed material” and may be specific to the methodology in use. Ranges may be established using a statistically significant number of values performed when the analysis was in control based on existing QC values.

The results for each QC material are entered and subjected to a multi-rule analysis such as Westgard QC rules. Multirule QC uses a combination of decision criteria, or control rules, to decide whether an analytical run is in-control or out-of-control control. The well-known Westgard multirule QC procedure uses 5 different control rules to judge the acceptability of an analytical run. By comparison, a single-rule QC procedure uses a single criterion or single set of control limits, such as a Levey-Jennings chart with control limits set as either the mean plus or minus 2 standard deviations (2s) or the mean plus or minus 3s. “Westgard rules” are generally used with 2 or 4 control measurements per run, which means they are appropriate when two different control materials are measured 1 or 2 times per material, which is the case in many chemistry applications. Some alternative control rules are more suitable when three control materials are analyzed, which is common for applications in hematology, coagulation, and immunoassays.

### EXAMPLE 3

Education

If is conceivable that an educational institution could implement a compliance management system including to ensure student-assigned tasks are completed to the best of their ability.

For instance, a student may have a homework assignment due, such as a lab report, possibly having a required word count, scheduled interim performance targets and completion due at a specified date. Often a student's parents have an interest in the successful completion of the task. The element could be the homework task itself having characteristics including the product and subject to rules including deadlines and product specifications. The initiating responsible representative may be the teacher, with successive responsible representatives being the student, the teacher, the parents, all of the above or each in an escalating sequence. It is conceivable that the student would actually conduct the task online through an interactive component of the compliance management system, such as the QAM, and if the task was not completed or for some other reason or another did not comply, then there would be a notification to the teacher and the parents. It may be that the teacher would be notified initially and only upon a second out-of-compliance status that the parents be notified as successive responsible representatives.

The embodiments of the invention in which an exclusive property or privilege is being claimed are defined as follows:

1. A method for directing compliance of an entity to rules applicable to one or more elements, the method comprising the steps of:
collecting data for each element and applying a computerized rule application system to each element's data for identifying whether each element has an in-compliance status or an out-of-compliance status;
entering a corrective action event in a corrective action register for each element having an out-of-compliance status; and
notifying a hierarchy of successive responsible representatives of each corrective action event until each element having a corrective action event has been corrected to an in-compliance status and removed from the corrective action register.

2. The method of claim 1 further comprising the step of waiting for a predetermined triggering event before notifying each successive responsible representative.

3. The method of claim 1 further comprising the step of correcting an element comprises toggling the status in the corrective action register.

4. The method of claim 3 wherein the notifying step, for each out-of-compliance element, further comprises the steps of:
displaying the corrective action event to a responsible representative assigned to the out-of-compliance element; and
accepting a toggling of the status of the out-of-compliance element for the corrective action event.

5. The method of claim 4 wherein the notifying step, for each out-of-compliance element, further comprises the step of displaying the one or more corrective action events to the responsible representative on an interactive calendar.

6. The method of claim 1 wherein the collecting data step is mandatory, further comprising:
demanding collection of the data for each element; and
assigning the element an out-of-compliance status failing collection of the data.

7. The method of claim 1 further comprising the steps of:
collecting the data of an element by an initial responsible representative; through a distributed network; and
notifying the initial responsible representative of the element's out-of-compliance status through the distributed network.

8. The method of claim 1 further comprising the steps of:
notifying an initial responsible representative of the corrective action events, the initial responsible representative being assigned from the hierarchy of success responsible representatives for each element;
removing corrective action events from the corrective action register that have been corrected to the in-compliance status since a previous notifying step;
monitoring the corrective action register for remaining corrective action events; and
notifying a successive responsible representative of the remaining corrective action events.

9. The method of claim 8 further comprising the step of repeating the removing, monitoring and notifying steps until all of the corrective action events have been corrected.

10. The method of claim 8 further comprising the step of applying the computerized rule application system in a distributed network.

11. The method of claim 10 wherein the corrective action register is on the network, further comprising the steps of:
notifying a successive responsible representative of the remaining corrective action events and displaying a toggle for correcting the status of an element; and
accepting a toggling of the status of the element toggle from a successive responsible representative.

12. The method of claim 8 wherein the monitoring step further comprises the steps of:
waiting for a predetermined trigger before monitoring the corrective action register; and
initiating the monitoring step upon receipt of the trigger.

13. The method of claim 12 wherein the trigger is the expiry of the predetermined period of time.

14. The method of claim 8 wherein the collecting data step further comprising:
demanding collection of the characteristic data; and
assigning the element an out-of-compliance status failing mandatory collection of the characteristic data.

15. The method of claim 8 wherein the notifying step further comprises the step of displaying one or more corrective action events in the corrective action register to the initial or successive responsible representative.

16. The method of claim 10 wherein the notifying step further comprises the steps of:
identifying the existence of one or more corrective action events in a compliance calendar interface to the network, to the initial or successive responsible representative; and
providing a navigational link on the network to details for each corrective action event.

17. The method of claim 8 wherein the monitoring step comprises re-applying the computerized rule application system to the at least one element.

18. The method of claim 8 wherein the triggering event is the expiry of a predetermined period of time.

19. The method of claim 8 wherein the triggering event is upon a change to the one or more characteristics of the at least one element.

20. The method of claim 8 wherein the triggering event is a query initiated by the initial or a successive responsible representative.

21. The method of claim 8 wherein the triggering event is upon a revision to the rules.

22. The method of claim 8 wherein the triggering event is the earlier of a revision to the rules, the expiry of a predetermined period of time, a change to the one or more characteristic of the at least one element, or a query initiated by the initial or a successive responsible representative.

23. The method of claim 10 further comprising the steps of:
displaying the compliance status of each element in a calendar interface accessible through the network, the calendar interface providing a correction toggle for each element having an out-of-compliance status;
enabling toggling of the compliance status by the initial or successive responsible representative through the calendar interface.

24. A system for directing entity compliance, the entity having at least one element subject to rules comprising:
a network;
at least one data collection device, adapted for connection to the network, for collecting data for one or more characteristics of at least one element;
a server computer system, adapted for connection to the network and for receiving said data from the data collection device and for storing said data;
a rule application program for applying compliance rules to the data for identifying an element having an out-of-compliance status; and
means for assigning a hierarchy of responsible representatives for each element; and
means for notifying a succession of responsible representatives of the out-of-compliance status of the element, the responsible representatives being selected from the hierarchy and notified through the network.

25. The system of claim 24 wherein the data collection device is a portable computer.

26. The system of claim 24 wherein the data collection device is an autonomous data collecting device.

27. The system of claim 26 wherein the portable computer operates a dynamic form application program, having one or more entry fields for accepting data for one of more characteristics of the at least one element.

28. The system of claim 27 wherein a responsible representative enters data into the entry fields.

29. The system of claim 27 wherein at least some of the fields are mandatory response fields.

30. The system of claim 27 wherein the dynamic form application program is updated when connected to the network.

31. The system of claim 24 wherein the notifying means comprise:
a corrective action register operative across the network;
a corrective action event entry in the corrective action register for each element that has an out-of-compliance status;
means for displaying the corrective action event to a responsible representative; and
means for toggling the status of the element.

32. The system of claim 31 wherein the corrective action event display means comprises:
a calendar having identification thereon of a corrective action events; and
a link to the corrective action register.
